(19) United States
(12) Patent Application Publication
(10) Pub. No.: US 2006/0125424 A1
(43) Pub. Date: Jun. 15, 2006

(54) Single ground scheme for CCFL circuitry

(75) Inventor: Richard L. Gray, Saratoga, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Analog Microelectronics, Inc., Santa Clara, CA (US)

(21) Appl. No.: 11/009,322

(22) Filed: Dec. 10, 2004

(51) Int. Cl. H05B 37/00

(52) U.S. Cl. 315/312

(57) ABSTRACT

Multiple CCFL circuits having pairs of CCFLs are described. Notably, for each CCFL, its output terminal can be directly returned to a system ground. A single ground bus servicing all CCFLs can significantly simplify wiring, thereby reducing manufacturing complexity and cost. For each transformer in the multiple CCFL circuit, its secondary winding outputs can be connected to the input terminals of a pair of CCFLs. For secondary winding terminals not connected to the CCFLs, each such terminal can be connected to ground, another secondary winding terminal, or a current sensing element. Advantageously, connections between secondary windings can be made out of phase.

### BACKGROUND OF THE INVENTION

1. Field of the Invention

The present invention relates to cold cathode fluorescent lighting (CCFL), and particularly to a method for driving multiple CCFL loads such that an output terminal of each CCFL is returned directly to ground.

2. Description of the Related Art

Liquid crystal displays (LCDS) are well known in the art of electronics. One of the largest power consuming devices in a notebook computer is the backlight for its LCD. The LCD typically uses a cold cathode fluorescent lamp (CCFL) for backlighting. In addition to notebook computers, CCFL backlights can be used in personal digital assistants (PDAs), some larger cell phones, LCD monitors, and LCD televisions. If used in LCD monitors and LCD televisions, multiple CCFLs are required to provide the necessary brightness for each application. For example, there are applications that can require up to 24 CCFL tubes for large screen LCD TVs.

Generally, a current sensing element coupled between an output terminal of the CCFL tube and a system ground senses the current in a CCFL in order for that current to be regulated. Specifically, this current sensing element, e.g. a diode rectifier and current sense resistor combination, sends a voltage proportional to the CCFL current to control circuitry, which facilitates changing the CCFL current as necessary.

For example, FIG. 1 illustrates a portion of a conventional CCFL circuit 100 including a transformer 101 having primary/secondary windings, an inductor 102 having a leakage inductance Lₗₑₐₖ coupled between the secondary side of transformer 101 and an input terminal of a CCFL 103, and a capacitor 104 having a parasitic capacitance C_{parasitic} coupled between the input terminal of CCFL 103 and a system ground. In this embodiment, a current sensing element 105 can include a diode rectifier formed by diodes D4 and D5 as well as a current sense resistor R9. In other embodiments, the current sensing element could include a current sensing transformer, a Hall effect sensor, or any other current sensing components.

The output of current sensing element 105 is provided to control circuitry 106, which can modulate the power into the input terminal of CCFL 103 to keep the CCFL current within regulation. For example, control circuitry 106 can modulate the duty cycle of a switching waveform at the primary side of transformer 101. The modulation of the duty cycle and exemplary control circuitry are explained in U.S. patent application Ser. No. 10/264,438, entitled “Method and System Of Driving A CCFL”, filed on Oct. 3, 2002, and incorporated by reference herein.

Notably, transformer 101 has a low voltage primary winding and a high voltage secondary winding. Further, current sensing element 105 is connected to the system ground. Specifically, in this embodiment, an anode of diode D4 is connected to the output terminal of CCFL 103, whereas a cathode of diode D4 is connected to resistor R9, which in turn is connected to system ground. The cathode of diode D4 is also connected to control circuitry 106. A cathode of diode D5 is connected to the anode of diode D4, whereas an anode of diode D5 is connected to system ground. Thus, in this configuration, CCFL 103 is not directly connected to system ground.

CCFL circuit 100 can be replicated to drive multiple tubes. For example, FIG. 2 illustrates a multiple CCFL system 200 including three CCFL circuits. In multiple CCFL system 200, CCFL circuits 100A, 100B, and 100C use current sensing elements 105A, 105B, and 105C, respectively, to control the currents through CCFLs 103A, 103B, and 103C. Notably, each CCFL circuit 100A, 100B, and 100C requires its own control circuit 106A, 106B, and 106C, thereby making the implementation of multiple CCFL configuration 200 quite expensive. Moreover, because there is no common connection for CCFLs 103A, 103B, and 103C, each CCFL tube requires its own high voltage connection (not shown for simplicity) as well as its own connection to its corresponding sensing element.

FIG. 3 illustrates a multiple CCFL circuit circuit 300 that infers CCFL current, thereby minimizing circuitry as well as cost. Specifically, multiple CCFL circuit 300 includes a transformer 301 having two secondary windings, i.e. 302A and 302B, connected in series between input terminals of CCFLs 303A and 303B. Notably, only CCFL 303A is further connected to current sensing element 105. In contrast, CCFL 303B is further connected directly to ground.

In this configuration, the current is sensed in only one of the CCFL legs, i.e. the current through CCFL 303A. However, because CCFLs 303A and 303B are connected in series and share the same flux path in the transformer, the current in CCFL 303B can be accurately inferred to be the same as the current in CCFL 303A. Therefore, multiple CCFL circuit 300 only requires one closed loop network, e.g. control circuit 106, to control the current in both CCFLs 303A and 303B.

Note that this technique can be extended to additional tubes. In this case, the incremental cost of adding tubes goes down as more tubes are added because the user only has to pay the overhead of the closed loop feedback network once no matter how many CCFLs are ultimately driven. For example, FIG. 4 illustrates another multiple CCFL circuit 400.

In multiple CCFL circuit 400, one control circuit, i.e. control circuit 106, can be used to generate signals OUTA, OUTAPB, and OUTC that, in turn, drive two transformers 401A and 401B, wherein transformer 401B drives CCFLs 402A and 402B whereas transformer 401A drives CCFLs 402C and 402D. Note that the secondary windings of transformers 401A and 402B are cross-coupled to equalize the currents through series-connected pairs of the four tubes. Because complementary pairs of tubes share the same transformer cores, the energy transferred to one pair of series-connected tubes is largely the same as the energy transferred to the other pair of series connected tubes.

In other words, if CCFLs 402A-402D are similar to each other and transformers 401A and 401B are also similar to each other, then the tube current through each CCFL can be characterized as substantially identical. Thus, in CCFL circuit configuration 400, the current detected in only one CCFL (i.e. CCFL 402D) can advantageously control the current through four CCFLs (i.e. CCFLs 402A-402D), thereby necessitating only one control circuit (i.e. control circuit 106).

However, it would be preferable if all CCFLs in a multi-tube application could be returned directly to ground. Specifically, a single ground bus servicing all CCFLs could significantly simplify the wiring for that application, thereby reducing manufacturing complexity and cost. Unfortunately, coupling an output terminal of each CCFL to ground still leaves the problem of how to sense the current in the CCFLs. Therefore, a need arises for a multi-tube configuration providing both a current sensing network as well as a single ground return.

### SUMMARY OF THE INVENTION

A method of providing a multiple CCFL circuit is described. Notably, for each CCFL, its output terminal can be directly returned to a system ground. A single ground bus servicing all CCFLs can significantly simplify wiring, thereby reducing manufacturing complexity and cost. For each transformer in the multiple CCFL circuit, its secondary winding outputs can be connected to the input terminals of a pair of CCFLs. For secondary winding terminals not connected to the CCFLs, each such terminal can be connected to ground, another secondary winding terminal, or a current sensing element. Advantageously, connections between secondary windings can be made out of phase.

A multiple CCFL circuit including two CCFLs and one transformer is also described. Note that a transformer can include a primary winding (having top and bottom terminals), a top secondary winding, and a bottom secondary winding. Note that the terms “top” and “bottom” are only meant to position various elements in relation to each other and can be easily extended to embodiments having different orientations, for example “top” and “bottom” windings can accurately describe the positions of exemplary windings. The transformer can be driven by signals provided on three lines. In one embodiment, a first line can be connected to a midpoint of the primary winding of the transformer, a second line can be connected to the top terminal of the primary winding of the transformer, and a third line can be connected to the bottom terminal of the primary winding of the transformer.

The first CCFL has its input terminal connected to one end of the top secondary winding of the transformer. The second CCFL has its input terminal connected to one end of the bottom secondary winding of the transformer. The other end of the bottom secondary winding is connected to ground. A current sensing element can be connected to another end of the top secondary winding of the transformer, thereby advantageously allowing the output terminals of both the first and second CCFLs to be returned directly to ground.

A multiple CCFL circuit including four CCFLs and two transformers is also described. In one embodiment, the first line can be connected to midpoints of the primary windings of the first and second transformers. The second line can be connected to the top terminal of the primary winding of the first transformer and the bottom terminal of the primary winding of the second transformer. The third line can be connected to the bottom terminal of the primary winding of the first transformer and the top terminal of the primary winding of the second transformer.

The first CCFL has its input terminal connected to one end of the top secondary winding of the first transformer. The second CCFL has its input terminal connected to one end of the bottom secondary winding of the first transformer. Another end of the bottom secondary winding of the first transformer is connected to ground. The third CCFL has its input terminal connected to one end of the top secondary winding of the second transformer. The fourth CCFL has its input terminal connected to one end of the bottom secondary winding of the second transformer.

In this embodiment, another end of the top secondary winding of the first transformer is connected to another end of the bottom secondary winding of the second transformer. The current sensing element can be connected to another end of the top secondary winding of the second transformer, thereby advantageously allowing the output terminals of the first, second, third, and fourth CCFLs to be returned directly to ground.

A multiple CCFL circuit including six CCFLs and three transformers is also described. In one embodiment, the first line can be connected to midpoints of the primary windings of the first, second, and third transformers. The second line can be connected to the top terminal of the primary winding of the first transformer, the bottom terminal of the primary winding of the second transformer, and the top terminal of the primary winding of the third transformer. The third line can be connected to the bottom terminal of the primary winding of the first transformer, the top terminal of the primary winding of the second transformer, and the bottom terminal of the primary winding of the third transformer.

The first CCFL has its input terminal connected to one end of the top secondary winding of the first transformer. The second CCFL has its input terminal connected to one end of the bottom secondary winding of the first transformer. The third CCFL has its input terminal connected to one end of the top secondary winding of the second transformer. The fourth CCFL has its input terminal connected to one end of the bottom secondary winding of the second transformer. The fifth CCFL has its input terminal connected to one end of the top secondary winding of the third transformer. The sixth CCFL has its input terminal connected to one end of the bottom secondary winding of the third transformer.

In this embodiment, another end of the top secondary winding of the first transformer is connected to another end of the bottom secondary winding of the second transformer. Another end of the bottom secondary winding of the first transformer is connected to ground. Another end of the top secondary winding of the second transformer is connected to another end of the bottom secondary winding of the third transformer. A current sensing element can be connected to another end of the top secondary winding of the third transformer, thereby advantageously allowing the output terminals of the first, second, third, fourth, fifth, and sixth CCFLs to be returned directly to ground.

In one embodiment, the current sensing element of the multiple CCFL circuit can include a diode rectifier and a current sense resistor. The multiple CCFL circuit can further include high voltage sense circuits connected to the input terminals of each CCFL. In one embodiment, the high voltage sense circuit can include a voltage divider.

### BRIEF DESCRIPTION OF THE FIGURES

FIG. 1 illustrates a portion of a conventional CCFL circuit including a current sensing element, e.g. a diode rectifier and current sense resistor combination. This current sensing element sends a voltage proportional to the CCFL current to control circuitry, which facilitates changing the CCFL current as necessary.

FIG. 2 illustrates a multiple CCFL system in which each CCFL circuit has its own control circuit.

FIG. 3 illustrates a multiple CCFL circuit in which the current of a first CCFL is detected using a current sensing element and the current of a second CCFL is inferred from the first CCFL.

FIG. 4 illustrates another multiple CCFL circuit in which the current of a first CCFL is detected using a current sensing element and the currents of all other CCFLs are inferred from the first CCFL.

FIGS. 5A-5C illustrate multiple CCFL circuits including two CCFLs and one transformer. In these circuits, the current of a first CCFL is detected using a current sensing element and the current of the second CCFL is inferred from the first CCFL. Notably, because the current sensing element is connected to a secondary winding of the transformer, the output terminals of both CCFLs can be returned directly to ground.

FIGS. 6A-6C illustrate multiple CCFL circuits including four CCFLs and two transformers. In these circuits, the current of one CCFL is detected using a current sensing element and the currents of all other CCFLs are inferred from the first CCFL. Notably, because the current sensing element is connected to a secondary winding of one transformer, the output terminals of the four CCFLs can be returned directly to ground

FIGS. 7A and 7B illustrate multiple CCFL circuits including six CCFLs and three transformers. In these circuits, the current of one CCFL is detected using a current sensing element and the currents of all other CCFLs are inferred from the first CCFL. Notably, because the current sensing element is connected to a secondary winding of one transformer, the output terminals of the six CCFLs can be returned directly to ground.

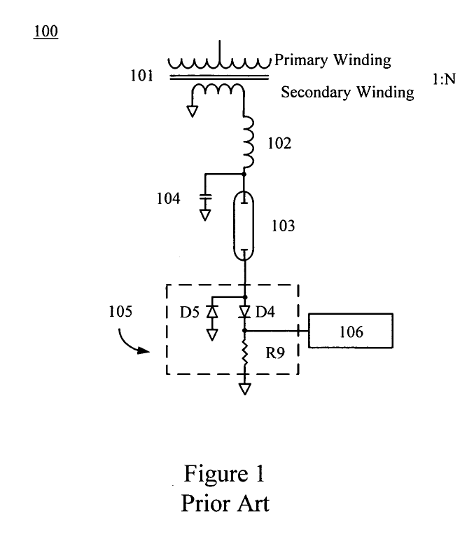

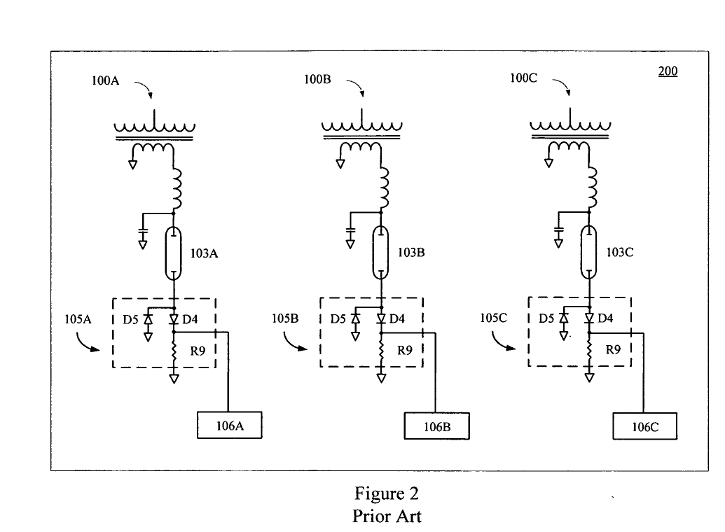

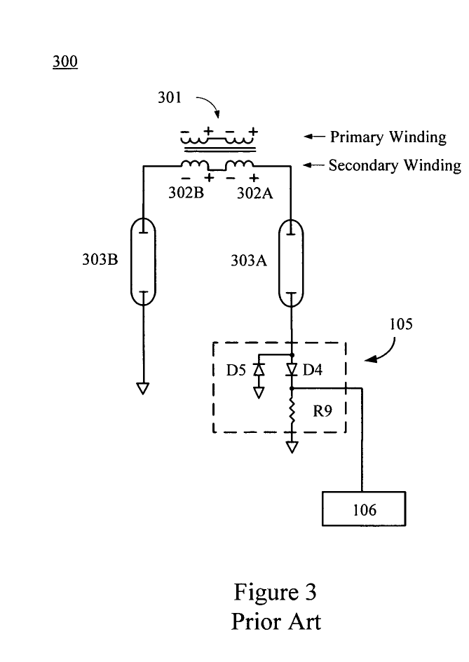

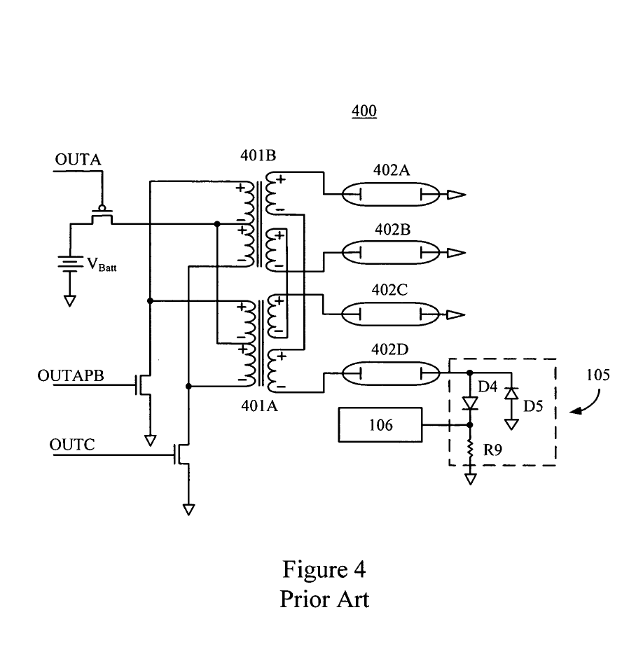

### DETAILED DESCRIPTION OF THE FIGURES

A multiple CCFL circuit, which includes a plurality of CCFLs, can sense current in such CCFLs using various techniques. A technique that requires a current sensing element for each CCFL is accurate, but prohibitively expensive for commercial applications. A technique that measures the current through one CCFL, by using a current sensing element connected to an output terminal of that CCFL, can accurately infer the current in the other CCFLs. Unfortunately, this technique prevents all CCFL output terminals to be returned directly to ground (i.e. all but one CCFL output terminal).

In accordance with one aspect of the invention, a current sensing element can be coupled to a secondary winding of a transformer in the multiple CCFL circuit. This configuration can measure the current associated with one CCFL and then accurately infer the current in the other CCFLs. Furthermore, this configuration can advantageously ensure that all CCFL output terminals can be returned directly to ground. A single ground bus servicing all CCFLs significantly simplifies the wiring for that application, thereby reducing manufacturing complexity and cost.

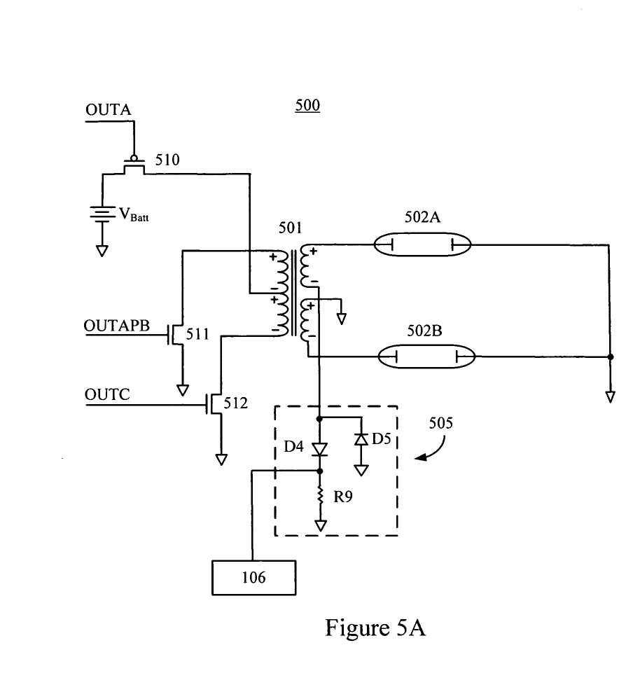

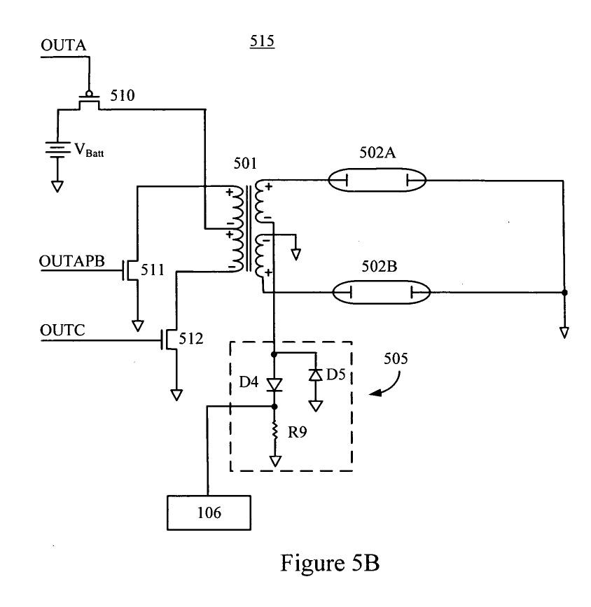

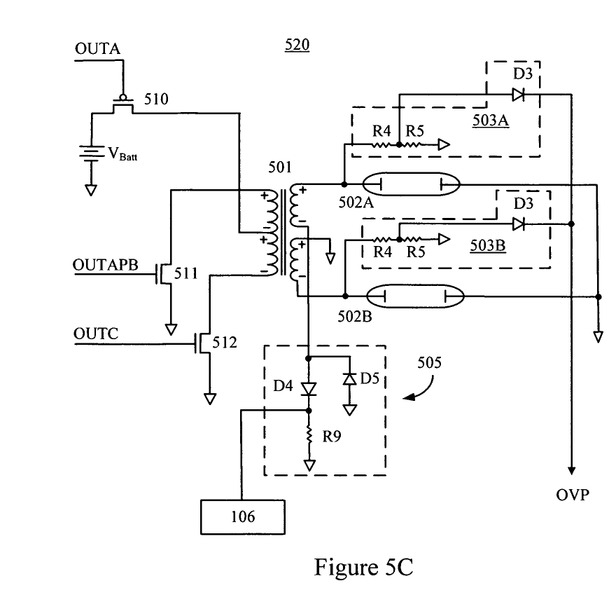

FIG. 5A illustrates one exemplary embodiment of a multiple CCFL circuit 500 including two CCFLs 502A and 502B having their output terminals connected directly to ground. In multiple CCFL circuit 500, a single transformer 501 is driven by signals OUTA, OUTAPB, and OUTC. Specifically, a PMOS transistor 510, which is connected between a battery voltage V_{Batt} and the midpoint of the primary winding of transformer 501, is driven by signal OUTA. Additionally, an NMOS transistor 511, which is connected between ground and a top terminal of the primary winding of transformer 501, is driven by signal OUTAPB. Another NMOS transistor 512, which is connected between ground and a bottom terminal of the primary winding of transformer 501, is driven by signal OUTC.

A top secondary winding of transformer 501 is coupled between a current sensing element 505 (which can include the components discussed in reference to current sensing element 105, e.g. diodes D4 and D5 as well as resistor R9) and an input terminal of CCFL 502A. A bottom secondary winding of transformer 501 can be coupled between ground and an input terminal of CCFL 502B. In circuit 500, the current through CCFL 502B can be advantageously inferred by determining the current provided to CCFL 502A.

Note that the terms “top” and “bottom”, as applied to the secondary windings and the terminals of the primary windings, are used to clarify the connections in various embodiments of multiple CCFL circuits shown in FIGS. 5A, 5B, 5C, 6A, 6B, 6C, 7A and 7B. Thus, in other orientations of multiple CCFL circuits, equivalent terms could be “right” and “left”, for example. Therefore, the terms “top” and “bottom” are only meant to position various elements in relation to each other and can be easily extended to embodiments having different orientations.

Note that a multiple CCFL circuit can be configured to provide a predetermined phase relation of the secondary transformer windings. This phase relation is discussed in U.S. patent application Ser. No. 10/10/264,438 (cited above). As used herein, the term “out of phase” means that, in normal operation, when one secondary output (i.e. a signal provided to an input terminal of a CCFL) is at 600V (+) then the other secondary output (of the same transformer) will be at −600V (−). In contrast, the term “in phase” means that, in normal operation, when one secondary output is at, for example, 600V (+) then the other secondary output (of the same transformer) will also be at 600V (+).

Multiple CCFL circuit 500 has an out of phase configuration, as indicated by the “+”s and “−”s placed adjacent the secondary windings of transformer 501. FIG. 5B illustrates a multiple CCFL circuit 515 similar to multiple CCFL circuit 500, but having an in phase configuration.

In one embodiment shown in FIG. 5C (an out of phase configuration), a multiple CCFL circuit 520 can further include high voltage sense circuits 503A and 503B. In one embodiment, each high voltage sense circuit 503A/503B can include resistors R4 and R5 connected in series between the input terminal of their respective CCFLs 502A/502B and ground, thereby creating a voltage divider. In this embodiment, a node between resistors R4 and R5 provides an OVP signal (rectified by a diode D3) proportional to the voltage across CCFLs 502A and 502B. This OVP signal can be provided to fault and control logic (described in U.S. patent application Ser. No. 10/264,438). If the OVP signal (and thus the CCFL voltage) is too high, then the fault and control logic can shut down multiple CCFL circuit 520 to prevent potentially dangerous conditions from developing.

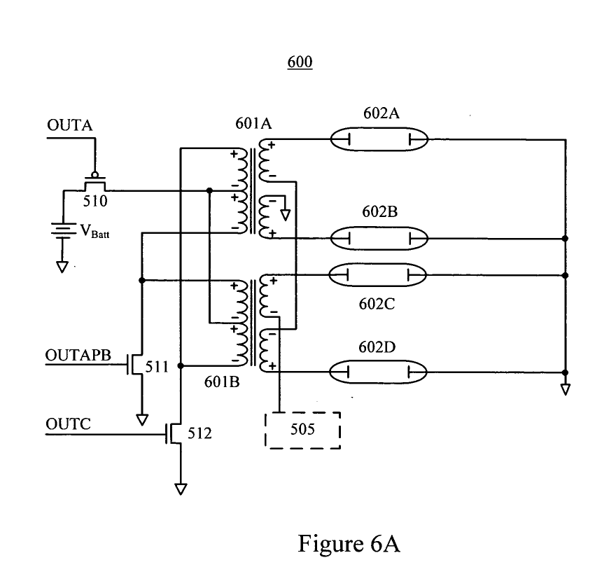

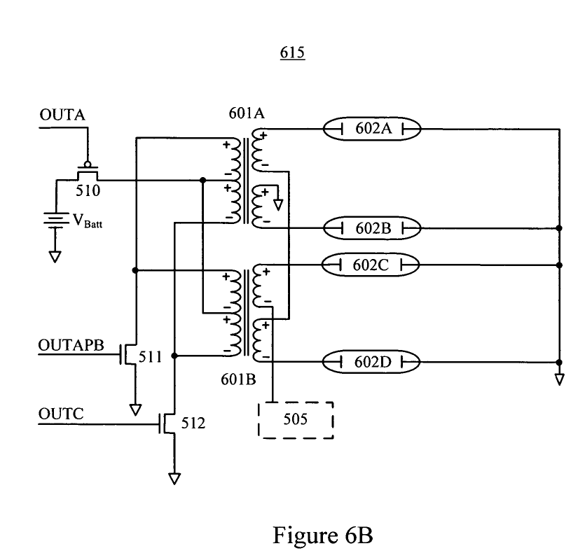

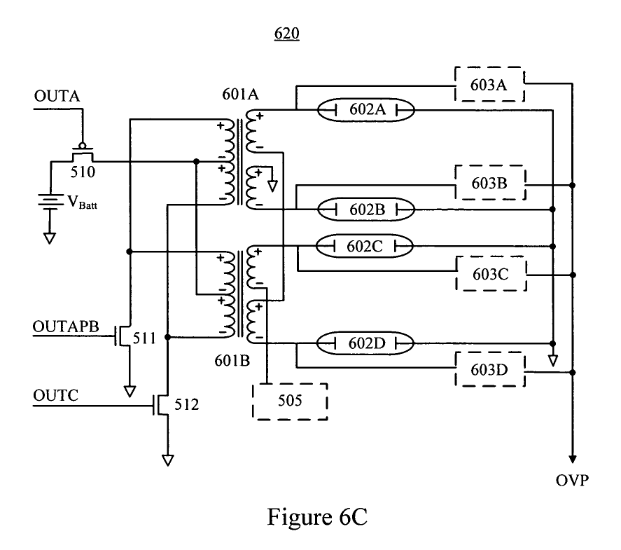

Advantageously, inferring the current through a CCFL by determining the current provided to another CCFL can be extended to other circuits having more CCFLs while ensuring that all CCFLs have output terminals returned to ground. For example, FIG. 6A illustrates one exemplary embodiment of a multiple CCFL circuit 600 including four CCFLs 602A, 602B, 602C, and 602D having their output terminals connected directly to ground. In multiple CCFL circuit 600, two transformers 601A and 601B can be driven by signals OUTA, OUTAPB, and OUTC. Specifically, PMOS transistor 510, which is connected between a battery voltage V_{Batt} and the midpoints of the primary windings of transformers 601A and 601B, is driven by signal OUTA. NMOS transistor 511, which is connected between ground and first terminals of the primary windings of transformers 601A and 601B (i.e. the bottom terminal of transformer 601A and the top terminal of transformer 601B), is driven by signal OUTAPB. NMOS transistor 512, which is connected between ground and second terminals of the primary windings of transformers 601A and 601B (i.e. the top terminal of transformer 601A and the bottom terminal of transformer 601B), is driven by signal OUTC.

The top secondary winding of transformer 601A and the bottom secondary winding of transformer 601B can be coupled in series between an input terminal of CCFL 602A and an input terminal of CCFL 602D. The bottom secondary winding of transformer 601A can be coupled between ground and an input terminal of CCFL 602B. The top secondary winding of transformer 601B can be coupled between current sensing element 505 (which can include the components discussed in reference to current sensing element 105, e.g. diodes D4 and D5 as well as resistor R9) and an input terminal of CCFL 602C. Notably, all output terminals of CCFLs 602A-602D can be connected directly to ground.

Note that secondary outputs of each of transformers 601A and 601B are in phase. Due to the particular wiring of the primary windings of transformers 601A and 601B, even though tubes 602A and 602B are driven with in phase signals, those in phase signals are of opposite phase compared to the signals driving 602C and 602D. FIG. 6B illustrates a multiple CCFL circuit 615 similar to multiple CCFL circuit 600, but having a different phase configuration. In the case of FIG. 6B, the two primary windings are driven in parallel and the secondary outputs of each transformer are of opposite phase. The result is that CCFLs 602A and 602C are driven by the same phase signal which is opposite to the phase driving CCFLS 602B and 602D In one embodiment shown in FIG. 6C, a multiple CCFL circuit 620 can further include high voltage sense circuits 603A-603D. In one embodiment, each high voltage sense circuit 603A-603D can include diode D3 and resistors R4/R5, as discussed in reference to high voltage sense circuit 503A/503B in FIG. 5C.

Note that the output phase determines the appropriate secondary interconnection between different transformers. Specifically, to keep secondary winding terminals that are not connected to CCFLs at the proper voltage, connections between secondary windings must be made out of phase. For example, (+) terminals must always be connected to (−) terminals and vice versa. Note that if secondary interconnections are connected (+) to (+) or (−) to (−), then currents in the secondary windings from different transformers would try to flow in opposition to each other, thereby producing extremely high voltages at the secondary interconnect nodes, arcing, and even circuit malfunction. An apparent inconsistency can be noted in the figures, e.g. FIG. 6A. In this case, the (+)-(+) and (−)-(−) terminals used in the secondary windings actually represent “effective” opposite polarities (although their markings would indicate polarities of the same phase). Notably, the effective polarities of the secondary windings are a function of the particular connections of the various primary winding. In other words, the figures may show a (+) terminal being connected to a (+) terminal, when in reality one of these (+)'s is electrically a (−) terminal.

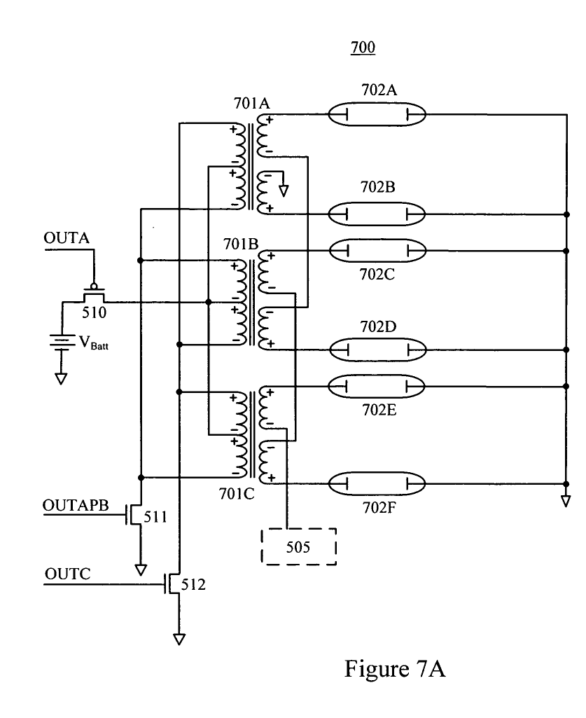

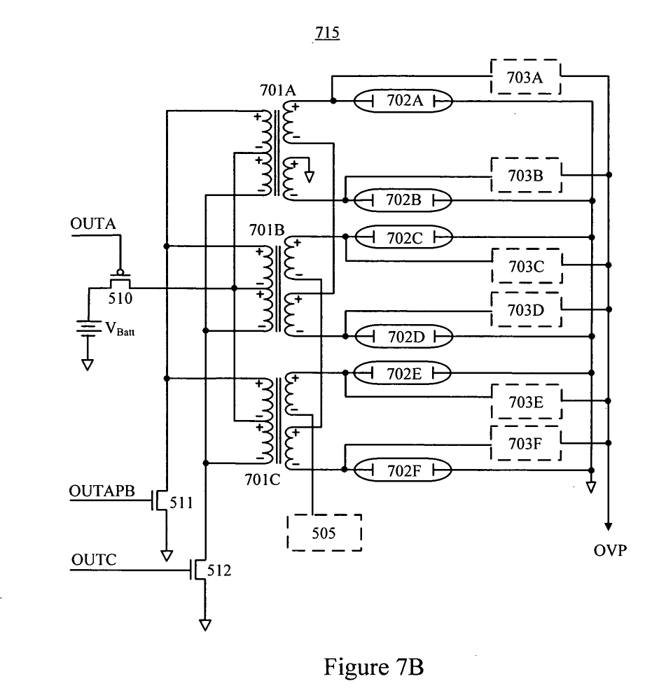

FIG. 7A illustrates one exemplary embodiment of a multiple CCFL circuit 700 including six CCFLs 702A-702F having their output terminals connected directly to ground. In multiple CCFL circuit 700, three transformers 701A, 701B, and 701C can be driven by signals OUTA, OUTAPB, and OUTC. Specifically, PMOS transistor 510, which is connected between a battery voltage V_{Batt} and the midpoints of the primary windings of transformers 701A, 701B, and 701C, is driven by signal OUTA. NMOS transistor 511, which is connected between ground and first terminals of the primary windings of transformers 701A, 701B, and 701C (i.e. the bottom terminal of transformer 701A, the top terminal of transformer 701B, and the bottom terminal of transformer 701C), is driven by signal OUTAPB. NMOS transistor 512, which is connected between ground and second terminals of the primary windings of transformers 701A, 701B, and 701C (i.e. the top terminal of transformer 701A, the bottom terminal of transformer 701B, and the top terminal of transformer 701C), is driven by signal OUTC. In this case, the primary windings of transformers 701A and 701C are wired in parallel and the primary winding of 701B is wired opposite to that parallel combination.

A top secondary winding of transformer 701A and a bottom secondary winding of transformer 701B can be coupled in series between an input terminal of CCFL 702A and an input terminal of CCFL 702D. A bottom secondary winding of transformer 701A can be coupled between ground and an input terminal of CCFL 702B. A top secondary winding of transformer 701B and a bottom secondary winding of transformer 701C can be coupled in series between an input terminal of CCFL 702C and an input terminal of CCFL 702F. A top secondary winding of transformer 701C can be coupled between current sensing element 505 (which can include the components discussed in reference to current sensing element 105, e.g. diodes D4 and D5 as well as resistor R9) and an input terminal of CCFL 702E. Notably, all output terminals of CCFLs 702A-702F can be connected directly to ground.

FIG. 7B illustrates a multiple CCFL circuit 715 similar to multiple CCFL circuit 700, but having a different phase configuration. Multiple CCFL circuit 715 can further include high voltage sense circuits 703A-703F. In one embodiment, each high voltage sense circuit 703A-703F can include diode D3 and resistors R4/R5, as discussed in reference to high voltage sense circuit 503A/503B in FIG. 5C.

Various embodiments of the present invention have been described herein. Those skilled in the art will recognize various component replacements or modifications that can be made to those embodiments. For example, even though the transformers are shown in specific configurations, the actual positioning of these transformers can be changed. Thus, referring to FIG. 7B, the positions of transformers 701B and 701C can be switched while still maintaining the same connections to CCFLs, the current sensing device, and their input drivers. Therefore, the scope of the present invention is only limited by the appended claims.

1. A multiple CCFL circuit comprising:
a transformer including a primary winding, a top secondary winding and a bottom secondary winding;
a first CCFL having an input terminal and an output terminal, wherein the output terminal is returned directly to ground, and wherein the input terminal is connected to one end of the top secondary winding of the transformer;
a current sensing element connected to another end of the top secondary winding of the transformer; and
a second CCFL having an input terminal and an output terminal, wherein the output terminal is returned directly to ground, wherein the input terminal is connected to one end of the bottom secondary winding of the transformer, and wherein the other end of the bottom secondary winding is connected to ground.

2. The multiple CCFL circuit of claim 1, wherein the primary winding includes a top terminal and a bottom terminal, and wherein the multiple CCFL circuit further includes:
a first line connected to a midpoint of the primary winding of the transformer;
a second line connected to the top terminal of the primary winding of the transformer;
a third line connected to the bottom terminal of the primary winding of the transformer.

3. The multiple CCFL circuit of claim 1, wherein the current sensing element includes a diode rectifier and a current sense resistor.

4. The multiple CCFL circuit of claim 1, further including high voltage sense circuits connected to the input terminals of the first and second CCFLs.

5. The multiple CCFL circuit of claim 4, wherein each high voltage sense circuit includes a voltage divider.

6. A multiple CCFL circuit comprising:
a first transformer including a primary winding, a top secondary winding and a bottom secondary winding;
a second transformer including a primary winding, a top secondary winding and a bottom secondary winding;
a first CCFL having an input terminal and an output terminal, wherein the output terminal is returned directly to ground, and wherein the input terminal is connected to one end of the top secondary winding of the first transformer;
a second CCFL having an input terminal and an output terminal, wherein the output terminal is returned directly to ground, and wherein the input terminal is connected to one end of the bottom secondary winding of the first transformer;
a third CCFL having an input terminal and an output terminal, wherein the output terminal is returned directly to ground, and wherein the input terminal is connected to one end of the top secondary winding of the second transformer;
a fourth CCFL having an input terminal and an output terminal, wherein the output terminal is returned directly to ground, and wherein the input terminal is connected to one end of the bottom secondary winding of the second transformer; and
a current sensing element connected to another end of the top secondary winding of the second transformer,
wherein another end of the top secondary winding of the first transformer is connected to another end of the bottom secondary winding of the second transformer, and wherein another end of the bottom secondary winding of the first transformer is connected to ground.

7. The multiple CCFL circuit of claim 6, wherein each primary winding of the first and second transformers includes a top terminal and a bottom terminal, and wherein the multiple CCFL circuit further including:
a first line connected to a midpoint of the primary winding of the first transformer and a midpoint of the primary winding of the second transformer;
a second line connected to the top terminal of the primary winding of the first transformer and the bottom terminal of the primary winding of the second transformer; and
a third line connected to the bottom terminal of the primary winding of the first transformer and the top terminal of the primary winding of the second transformer.

8. The multiple CCFL circuit of claim 6, wherein the current sensing element includes a diode rectifier and a current sense resistor.

9. The multiple CCFL circuit of claim 6, further including high voltage sense circuits connected to the input terminals of the first, second, third, and fourth CCFLs.

10. The multiple CCFL circuit of claim 9, wherein each high voltage sense circuit includes a voltage divider.

11. A multiple CCFL circuit comprising:
a first transformer including a primary winding, a top secondary winding and a bottom secondary winding;
a second transformer including a primary winding, a top secondary winding and a bottom secondary winding;
a third transformer including a primary winding, a top secondary winding and a bottom secondary winding;
a first CCFL having an input terminal and an output terminal, wherein the output terminal is returned directly to ground, and wherein the input terminal is connected to one end of the top secondary winding of the first transformer;
a second CCFL having an input terminal and an output terminal, wherein the output terminal is returned directly to ground, and wherein the input terminal is connected to one end of the bottom secondary winding of the first transformer;
a third CCFL having an input terminal and an output terminal, wherein the output terminal is returned directly to ground, and wherein the input terminal is connected to one end of the top secondary winding of the second transformer;
a fourth CCFL having an input terminal and an output terminal, wherein the output terminal is returned directly to ground, and wherein the input terminal is connected to one end of the bottom secondary winding of the second transformer; and
a fifth CCFL having an input terminal and an output terminal, wherein the output terminal is returned directly to ground, and wherein the input terminal is connected to one end of the top secondary winding of the third transformer;
a sixth CCFL having an input terminal and an output terminal, wherein the output terminal is returned directly to ground, and wherein the input terminal is connected to one end of the bottom secondary winding of the third transformer;
a current sensing element connected to another end of the top secondary winding of the third transformer,
wherein another end of the top secondary winding of the first transformer is connected to another end of the bottom secondary winding of the second transformer,
wherein another end of the bottom secondary winding of the first transformer is connected to ground, and
wherein another end of the top secondary winding of the second transformer is connected to another end of the bottom secondary winding of the third transformer.

12. The multiple CCFL circuit of claim 11, wherein each primary winding of the first, second, and third transformers further includes a top terminal and a bottom terminal, and wherein the multiple CCFL circuit further includes:
a first line connected to a midpoint of the primary winding of the first transformer, a midpoint of the primary winding of the second transformer, and a midpoint of the primary winding of the third transformer;
a second line connected to the top terminal of the primary winding of the first transformer, the bottom terminal of the primary winding of the second transformer, and the top terminal of the primary winding of the third transformer;
a third line connected to the bottom terminal of the primary winding of the first transformer, the top terminal of the primary winding of the second transformer, and the bottom terminal of the primary winding of the third transformer;

13. The multiple CCFL circuit of claim 11, wherein the current sensing element includes a diode rectifier and a current sense resistor.

14. The multiple CCFL circuit of claim 11, further including high voltage sense circuits connected to the input terminals of the first, second, third, fourth, fifth, and sixth CCFLs.

15. The multiple CCFL circuit of claim 14, wherein each high voltage sense circuit includes a voltage divider.

16. A method of providing a multiple CCFL circuit, each CCFL including an input terminal and an output terminal, the method comprising:
for each CCFL, directly returning the output terminal to a system ground;
for each transformer, connecting secondary winding outputs to the input terminals of a pair of CCFLs; and
for secondary winding terminals not connected to the CCFLs, connecting each such terminal to one of ground, another secondary winding terminal, and a current sensing element, wherein connections between secondary windings are made out of phase.
